(19) United States
(12) Patent Application Publication
(10) Pub. No.: US 2023/0213705 A1
(43) Pub. Date: Jul. 6, 2023

(54) HARDENED FIBER OPTIC ADAPTER THAT COUPLES A HARDENED FIBER OPTIC CONNECTOR WITH A FIBER CABLE LEAD OF A DROP TERMINAL

(71) Applicant: PPC BROADBAND, INC., East Syracuse, NY (US)

(72) Inventors: William L. CRAWFORD, Syracuse, NY (US); Peter A. CARAPELLA, Fayetteville, NY (US)

(73) Assignee: PPC BROADBAND, INC., East Syracuse, NY (US)

(21) Appl. No.: 18/092,078

(22) Filed: Dec. 30, 2022

Related U.S. Application Data
(60) Provisional application No. 63/295,240, filed on Dec. 30, 2021.

(51) Int. Cl. G02B 6/38; G02B 6/44

(52) U.S. Cl. CPC G02B 6/3825; G02B 6/3821; G02B 6/3877; G02B 6/4401

(57) ABSTRACT

A hardened fiber optic adapter that may include a body portion having a first end portion that is configured to receive a hardened fiber optic connector and a second end portion that may be located opposite to the first end portion, a flexible fiber cable lead portion that may include an optical fiber cable and a protection tube portion that may be configured to surround the optical fiber cable, and an adapter subassembly portion that may be configured to be coupled with a preterminated end of the optical fiber cable at a first end portion of the flexible fiber cable lead. A second end portion of the flexible fiber cable lead portion may be configured to be coupled with a drop terminal such that the adapter is permitted to be moved relative to the drop terminal to a predetermined connection orientation that is configured to allow the adapter to be connected to a hardened fiber optic connector.

### CROSS-REFERENCE TO RELATED APPLICATION

This application claims the benefit of U.S. Provisional Application No. 63/295,240, filed Dec. 30, 2021, which is currently pending, the disclosure of which is hereby incorporated by reference herein in its entirety.

### TECHNICAL FIELD

The present disclosure relates generally to a hardened fiber optic adapter and, more particularly, to a hardened fiber optic adapter that couples a hardened fiber optic connector with a fiber cable lead of a drop terminal, such as, for example, a flexible drop terminal or network access point.

### BACKGROUND

Optical fiber systems are increasingly used in a variety of communications applications, including voice, video, and data transmissions, because they offer a high bandwidth for signal transmission, low noise operation, and inherent immunity to electromagnetic interference. Such systems typically require connections of optical fibers at various points in the network. For example, connection points are commonly needed to (i) connect individual optical fiber cable lengths to create a longer continuous optical fiber, (ii) create branching points that reroute fibers in the same cable in different directions as needed to provide fibers at desired or predetermined locations, and (iii) connect active and passive components of the system.

One such connection point is a flexible drop terminal or a network access point (NAP) enclosure. Conventional flexible drop terminals include a sealed enclosure that protects the transition of fibers from a distribution fiber cable to one or more drop fiber cables. Such conventional flexible drop terminals are typically rigid boxes with connection ports fixed to the box at a predetermined angle. These conventional flexible drop terminals can cause difficulty for technicians with installation on a pole or in a pedestal/vault when one or more drop fiber cables need to be connected to one of the connection ports of the flexible drop terminal. Further, such installation difficulty can create craft error when hardened fiber optic connectors (HFOCs) are connected to such conventional flexible drop terminals in the field.

It may be desirable to provide a hardened fiber optic adapter that is configured to be coupled with a drop terminal such that the adapter is permitted to be moved relative to the drop terminal to a desired or predetermined orientation that is configured to allow the adapter to be connected to a hardened fiber optic connector.

### SUMMARY

According to various embodiments of the disclosure, a hardened fiber optic adapter may include a body portion having a first end portion that is configured to receive a hardened fiber optic connector and a second end portion that may be located opposite to the first end portion, a flexible fiber cable lead portion that may include an optical fiber cable and a protection tube portion that may be configured to surround the optical fiber cable, and an adapter subassembly portion that may be configured to be coupled with a preterminated end of the optical fiber cable at a first end portion of the flexible fiber cable lead. The adapter may further include a crimp member that may be configured to couple the protection tube portion of the flexible fiber cable lead portion with the body portion at the second end portion of the body portion, and a biasing member that may be configured to urge the adapter subassembly portion in axial direction toward the first end portion of the body portion. The first end portion of the body portion may be configured to include an internal threaded portion that may be configured to be threadedly coupled with an external threaded portion of a hardened fiber optic connector, the adapter subassembly portion may include a first inner body portion and a second inner body portion that may be configured to be fixedly coupled together and to receive a split sleeve that may be configured to extend through coaxial openings in the first inner body portion and the second inner body portion, and the first inner body portion that may be configured to be coupled with a ferrule holder portion of the preterminated end of the optical fiber cable to axially engage or fix the ferrule holder portion with the first inner body portion. The adapter subassembly portion may configured to provide an interface to mechanically and optically couple the preterminated end of the optical fiber cable with a hardened fiber optic connector that may be threadedly coupled with the internal threaded portion at the first end portion of the body portion, the split sleeve may be configured to receive and align a ferrule of the preterminated end of the optical fiber cable and a ferrule of a hardened fiber optic connector that may be threadedly coupled with the internal threaded portion at the first end portion of the body portion, and the body portion may include a keyed receptable portion that may be configured to receive a keyed plug portion of a hardened fiber optic connector so as to provide a first desired or predetermined connection orientation that may be configured to allow the hardened fiber optic connector to be connected to the body portion. A second end portion of the flexible fiber cable lead portion may be configured to be coupled with a drop terminal such that the adapter may be permitted to be moved relative to the drop terminal to a second desired or predetermined connection orientation that is configured to allow the adapter to be connected to a hardened fiber optic connector.

According to various aspects of the above embodiment, the adapter may further include a heat shrink that is configured to be applied to an outside of the flexible fiber cable lead portion and the second end portion of the body portion to provide a weathertight seal at the connection there between.

According to various aspects of any of the above embodiments, the biasing member comprises a spring.

According to various aspects of any of the above embodiments, the optical fiber cable comprises a cable having annular grooves spaced apart from one another along a length of the cable.

According to various aspects of any of the above embodiments, the protection tube portion comprises a duct having annular grooves spaced apart from one another along a length of the duct.

According to various embodiments of the disclosure, a hardened fiber optic adapter may include a body portion having a first end portion that may be configured to receive a hardened fiber optic connector and a second end portion that may be located opposite to the first end portion, a flexible fiber cable lead portion may include an optical fiber cable and a protection tube portion that may be configured to surround at least a portion of the optical fiber cable, and an adapter subassembly portion that may be configured to be coupled with a preterminated end of the optical fiber cable at a first end portion of the flexible fiber cable lead. The adapter subassembly portion may be configured to be coupled with a ferrule holder portion of the preterminated end of the optical fiber cable so as to axially engage or fix the ferrule holder portion with the adapter subassembly portion, and the adapter subassembly portion may be configured to provide an interface so as to mechanically and optically couple the preterminated end of the optical fiber cable with a hardened fiber optic connector that is coupled with the first end portion of the body portion. The second end portion of the flexible fiber cable lead portion may be configured to be coupled with a drop terminal such that the adapter may be permitted to be moved relative to the drop terminal to a desired or predetermined connection orientation that is configured to allow the adapter to be connected to a hardened fiber optic connector.

According to various aspects of any of the above embodiments, the adapter further includes a heat shrink that is configured to be applied to an outside of the flexible fiber cable lead portion and the second end portion of the body portion so as to provide a weathertight seal at a connection portion there between.

According to various aspects of any of the above embodiments, the optical fiber cable comprises a cable having annular grooves spaced apart from one another along a length of the cable.

According to various aspects of any of the above embodiments, the protection tube portion comprises a duct having annular grooves spaced apart from one another along a length of the duct.

According to various aspects of any of the above embodiments, wherein the adapter further includes a crimp member that is configured to couple the protection tube portion of the flexible fiber cable lead portion with the body portion at the second end portion of the body portion.

According to various aspects of any of the above embodiments, wherein the adapter further includes a biasing member that is configured to urge the adapter subassembly portion in axial direction toward the first end portion of the body portion.

According to various aspects of any of the above embodiments, the biasing member comprises a spring.

According to various aspects of any of the above embodiments, the first end portion of the body portion is configured to include an internal threaded portion that is configured to be threadedly coupled with an external threaded portion of a hardened fiber optic connector.

According to various aspects of any of the above embodiments, the adapter subassembly includes a first inner body portion and a second inner body portion that are configured to be fixedly coupled together.

According to various aspects of any of the above embodiments, the adapter subassembly is configured to receive a split sleeve that is configured to extend through an opening in the adapter subassembly, and wherein the split sleeve is configured to receive and align a ferrule of the preterminated end of the optical fiber cable with a ferrule of a hardened fiber optic connector that is coupled with the first end portion of the body portion.

According to various aspects of any of the above embodiments, the predetermined connection orientation comprises a first predetermined connection orientation, and the body portion includes a keyed receptable portion that is configured to selectively receive a keyed plug portion of a hardened fiber optic connector so as to provide a second predetermined connection orientation that is configured to allow the hardened fiber optic connector to be connected to the body portion.

According to various aspects of any of the above embodiments, the adapter subassembly portion is configured to be coupled with a ferrule holder portion of the preterminated end of the optical fiber cable to axially fix the ferrule holder portion with the adapter subassembly portion.

According to various embodiments of the disclosure, a hardened fiber optic adapter may include a body portion having a first end portion that may be configured to receive a hardened fiber optic connector and a second end portion that may be located opposite to the first end portion, a flexible fiber cable lead portion may include an optical fiber cable and a protection tube portion that may be configured to surround at least a portion of the optical fiber cable, and an adapter subassembly portion that may be configured to be coupled with a preterminated end of the optical fiber cable at a first end portion of the flexible fiber cable lead. A second end portion of the flexible fiber cable lead portion may be configured to be coupled with a drop terminal so as to permit the adapter to be moved relative to the drop connector to a desired or predetermined connection orientation so as to allow the adapter to be connected to a hardened fiber optic connector.

According to various aspects of any of the above embodiments, wherein the adapter further includes a heat shrink that is configured to be applied to an outside of the flexible fiber cable lead portion and the second end portion of the body portion so to provide a weathertight seal at a connection portion there between.

According to various aspects of any of the above embodiments, the optical fiber cable comprises a cable having annular grooves that are spaced apart from one another along a length of the cable.

According to various aspects of any of the above embodiments, the protection tube portion comprises a duct having annular grooves that are spaced apart from one another along a length of the duct.

According to various aspects of any of the above embodiments, wherein the adapter further includes a crimp member that is configured to couple the protection tube portion of the flexible fiber cable lead portion with the body portion at the second end portion of the body portion.

According to various aspects of any of the above embodiments, the adapter a biasing member that is configured to urge the adapter subassembly portion in an axial direction toward the first end portion of the body portion.

According to various aspects of any of the above embodiments, the biasing member comprises a spring.

According to various aspects of any of the above embodiments, the first end portion of the body portion is configured to include an internal threaded portion that is configured to be threadedly coupled with an external threaded portion of a hardened fiber optic connector.

According to various aspects of any of the above embodiments, the adapter subassembly includes a first inner body portion and a second inner body portion that are configured to be fixedly coupled together.

According to various aspects of any of the above embodiments, the adapter subassembly is configured to receive a split sleeve that is configured to extend through an opening in the adapter subassembly, and wherein the split sleeve is configured to receive and align a ferrule of the preterminated end of the optical fiber cable with a ferrule of a hardened fiber optic connector that is coupled with the first end portion of the body portion.

According to various aspects of any of the above embodiments, the predetermined connection orientation comprises a first predetermined connection orientation, and the body portion includes a keyed receptable portion that is configured to receive a keyed plug portion of a hardened fiber optic connector to provide a second predetermined connection orientation that is configured to allow the hardened fiber optic connector to be connected to the body portion.

According to various aspects of any of the above embodiments, the adapter subassembly portion is configured to be coupled with a ferrule holder portion of the preterminated end of the optical fiber cable to axially fix the ferrule holder portion with the adapter subassembly portion.

According to various aspects of any of the above embodiments, the adapter subassembly portion is configured to provide an interface that is configured to mechanically and optically couple the preterminated end of the optical fiber cable with a hardened fiber optic connector that is coupled with the first end portion of the body portion.

According to various aspects of any of the above embodiments, the second end portion is opposite to the first end portion.

According to various aspects of any of the above embodiments, the adapter subassembly portion is configured to be coupled with the preterminated end of the optical fiber cable at a first end portion of the flexible fiber cable lead.

Various aspects of the aforementioned hardened fiber optic adapters, as well as other embodiments, objects, features, and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of an exemplary flexible drop terminal that includes an enclosure having a plurality of output fiber optic cables extending from the enclosure according to various aspects of the disclosure.

FIG. 2 is an exploded perspective view of an exemplary adapter assembly in accordance with various aspects of the disclosure.

FIG. 3 is an exploded perspective view of an exemplary adapter subassembly of the adapter assembly of FIG. 2.

FIG. 4 is a perspective view of the exemplary adapter subassembly of FIG. 3 coupled with an output fiber optic cable.

FIG. 5 is a side cross-sectional view of the exemplary adapter subassembly and output fiber optic cable of FIG. 4.

FIG. 6 is a side cross-sectional view of the exemplary adapter assembly of FIG. 2 with the dust cap and tether removed.

FIG. 7 is a perspective view of the exemplary adapter assembly of FIG. 2.

FIG. 8 is a side cross-sectional view of the exemplary adapter assembly of FIG. 2.

FIG. 9 is a perspective view of the exemplary adapter assembly of FIG. 2 coupled with a hardened fiber optic connector.

FIG. 10 is a side cross-sectional view of the exemplary adapter assembly and hardened fiber optic connector of FIG. 9.

FIG. 11 is an enlarged side cross-sectional view of the exemplary adapter assembly and hardened fiber optic connector of FIG. 9.

### DETAILED DESCRIPTION OF EMBODIMENTS

As a preface to the detailed description, it should be noted that, as used in this specification and the appended claims, the singular forms “a”, “an” and “the” include plural referents, unless the context clearly dictates otherwise.

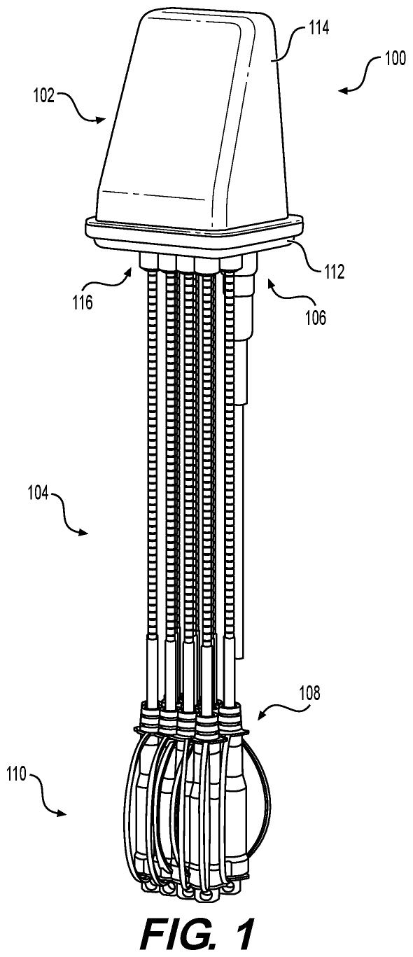

FIG. 1 illustrates an exemplary flexible drop terminal or network access point (NAP) 100 according to various aspects of the disclosure. The flexible drop terminal 100 includes a housing (or enclosure) 102, a plurality of output fiber optic cables 104 having first ends 106 coupled with and extending from ports 116 of the housing 102, and fiber optic adapters 110 connected to second ends 108 of the output fiber optic cables 104. In some aspects, the housing 102 may be a weatherproof housing, and the fiber optic adapters 110 may be hardened fiber optic adapters. In various aspects, the output fiber optic cables 104 may be Miniflex® fiber cables.

The housing 102 may include a base 112 and a cover 114. In various aspects, the base 112 and the cover 114 may be ultrasonically welded together to provide an environmental seal that protects the interior of the housing 102 from external environment. In some embodiments, the base 112 may include one input port configured to receive a multifiber optic input cable and twelve output ports configured to receive the output fiber optic cables 104. The base 112 may include fiber management features (not shown) configured to facilitate routing of fiber optic cables while ensuring that the fiber optic cables maintain at last a minimum bend radius to prevent signal losses as the optical signal negotiates the arcuate path, curve, or bend of the fiber optic cables.

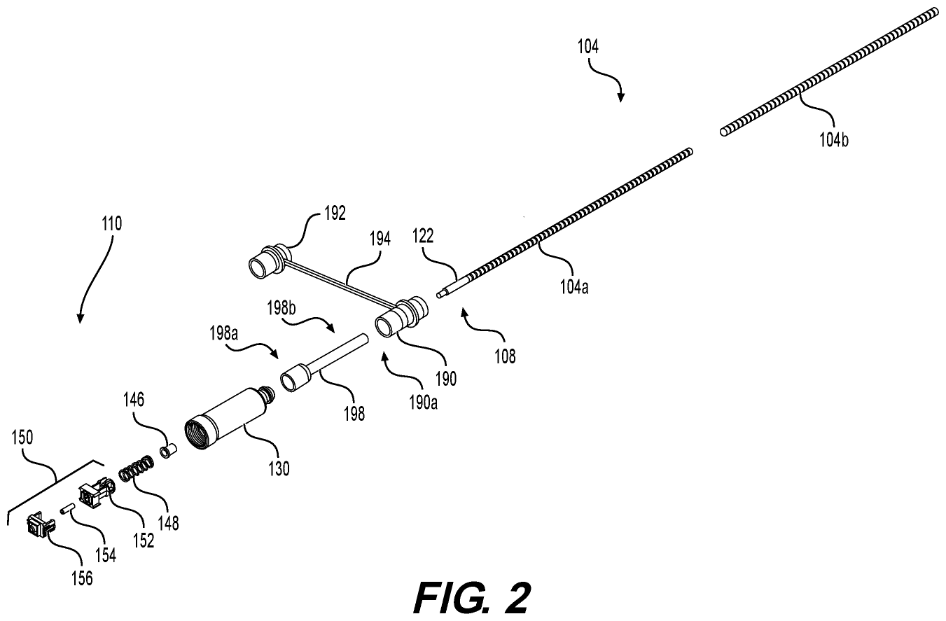

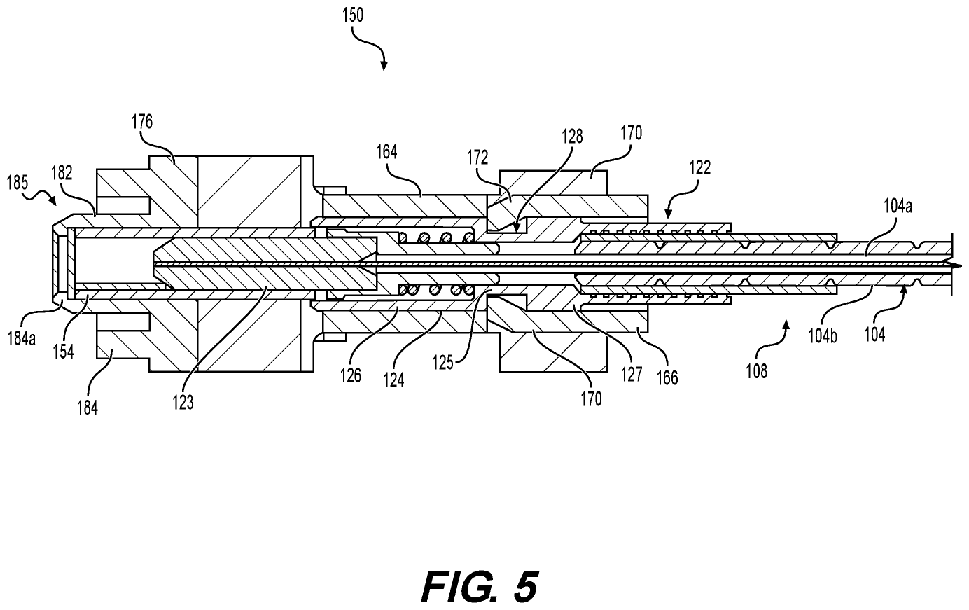

Referring to FIG. 2, the output fiber optic cable 104 may include a fiber cable 104a, for example, a 3 mm Miniflex® fiber cable, in a protection tube 104b, for example, a 5 mm Miniflex® duct. As best illustrated in FIG. 5, the second end 108 of the fiber optic cable 104a is preterminated by a fiber connector 122, which includes a ferrule 123 and a ferrule holder 124, as would be understood by persons of ordinary skill in the art. The fiber optic cable 104a holds a single strand of 125 pm diameter single mode optical fiber, which may be protected by buffering layers and an outer sheath. The optical fiber is held in a bore of the ferrule 123, as would be understood by persons skilled in the art. The fiber connector 122 may be, for example, a PPC® Balistix (QuikPush®) connector. The ferrule holder 124 includes a neck portion 125 formed by an annular groove 128 between a first end portion 126 and a second end portion 127 of the ferrule holder 124. The ferrule 123 extends from the first end portion 126 of the ferrule holder 124.

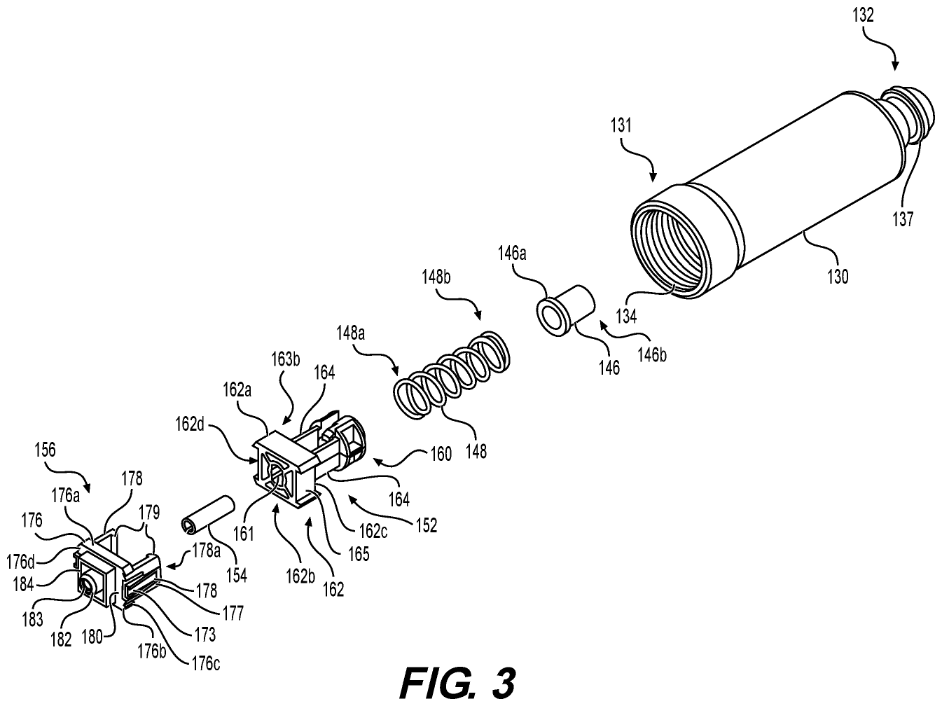

As illustrated in FIGS. 2 and 3, the hardened fiber optic adapter 110 includes an outer body 130, a crimp 146, a spring 148, and an adapter subassembly 150. The adapter subassembly 150 includes a first inner body 152, a split sleeve 154, and a second inner body 156. In some aspects, the hardened fiber optic adapter 110 also includes a boot 190 and a dust cap 192 coupled with the boot 190 via a tether 194. A heat shrink 198 is configured to couple the outer body 130 with the protection tube 104b.

Referring now to FIGS. 3-8, the first inner body 152 includes a first end portion 160 configured to be coupled with the fiber connector 122 and a second end portion 162 configured to be coupled with the second inner body 156, as discussed in detail below. The split sleeve 154 is substantially cylindrical with a cut along its entire axial length, which allows the split sleeve 154 to be compressed radially inward. The second end portion 162 of the first inner body 152 includes an opening 161 sized to receive the split sleeve 154 in a compressed configuration such that the split sleeve 154 is biased radially outward against the wall of the opening 161 to maintain a coupled relationship with the second end portion 162 of the first inner body 152.

The second end portion 162 of the first inner body 152 includes opposed first and second outer surfaces 162a, 162b that are planar and third and fourth outer surfaces 162c, 162d that include notches 165. The third and fourth outer surfaces 162c, 162d extend from the first outer surface 162a to the second outer surface 162b and are perpendicular to the first and second outer surfaces 162a, 162b. The second end portion 162 of the first inner body 152 includes a first surface 163a facing away from the first end portion 160 and toward the second inner body 154 and a second surface 163b facing toward the first end portion 160 and away from the second inner body 154.

A pair of wall portions 164 extend from the first end portion 160 to the second end portion 162 in an axial direction substantially parallel to the notched third and fourth outer surfaces 162c, 162d. The wall portions 164 extend parallel to one another and are spaced apart by a distance that permits the first end portion 126 of the ferrule holder 124 to extend therebetween such that the ferrule 123 can extend into the split sleeve 154 in the opening 161 of the first end portion 160, as best illustrated in FIG. 5. In some aspects, the first end portion 160, the second end portion 162, and the wall portions 164 are a single monolithic structure of unitary construction.

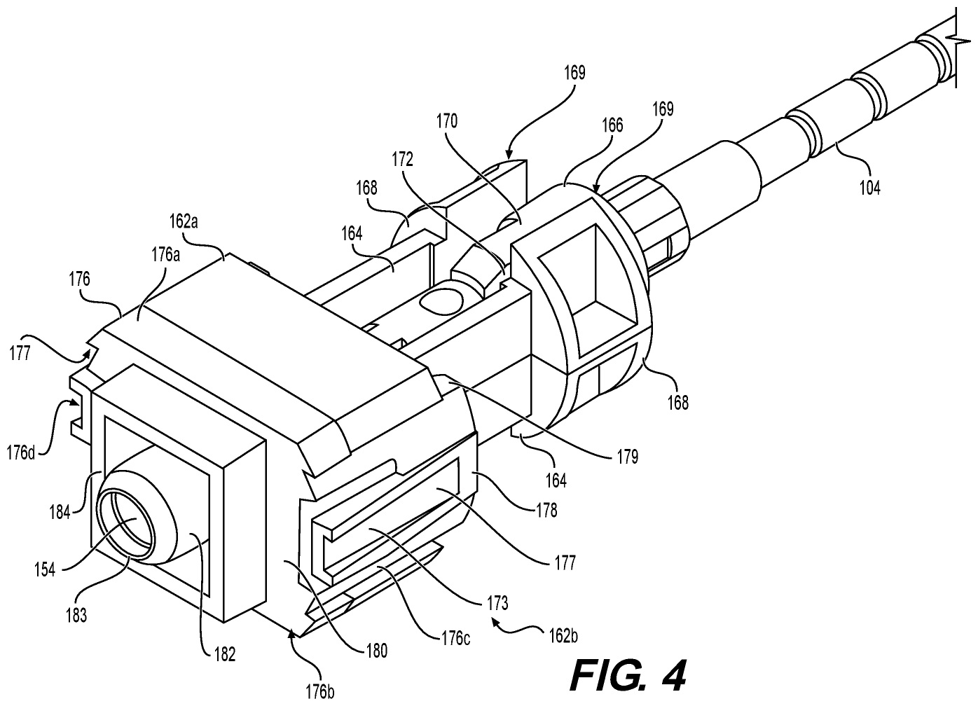

The first end portion 160 includes a circular end wall 166 (FIG. 4) having a circumference sized such that a first end 148a of the spring 148 can be disposed thereon. The first end portion 160 further includes a pair of curved flange portions 168 that extend from the circular end wall 166 in the axial direction and are spaced apart by a distance that permits the second end portion 127 of the ferrule holder 124 to extend therebetween. The curved flange portions 168 define an outer profile having a circumference greater than the circumference of the circular end wall 166 such that the curved flange portions 168 define shoulders 169 against which the first end 148a of the spring 148 may be engaged.

The first end portion 160 also includes a pair of cantilevered fingers 170 that extend in the axial direction from the circular end wall 166 toward the second end portion 162. Each of the cantilevered fingers 170 includes a lip portion 172 that extends radially inward at a free end 170a of the finger 170. The lip portion 172 extends radially inward by a distance that permits the lip portion 172 to be received in the neck portion 125 of the ferrule holder 124, as best shown in FIG. 5. The fingers 170 are radially flexible such that the fingers 170 can be urged radially outward when the first inner body 152 is slid over the first end portion 126 of the ferrule holder 124 and return toward its rest configuration when the lip portions 172 are received in the neck portion 125. When the lip portions 172 are received in the neck portion 125, the first inner body 152 is axially fixed relative to the ferrule holder 124.

The second inner body 156 includes a wall portion 176 having opposed first and second outer surfaces 176a, 176b that are planar. The first and second outer surfaces 176a, 176b are aligned with the first and second outer surfaces 162a, 162b of the second end portion 162 of the first inner body 152 such that the first outer surfaces 162a, 176a define a contiguous planar surface and the second outer surfaces 162b, 176b define another contiguous planar surface.

The wall portion 176 includes third and fourth outer surfaces 176c, 176d that extend from the first outer surface 176a to the second outer surface 176b. The third and fourth outer surfaces 176c, 176d include convexly curved notches 177, and a latching portion 173 is disposed at the notches 177 and extends from a surface of the notch 173 and extends away from the first end inner body 152 and toward an end surface 180 to a free end. The latching portion 173 is biased outwardly and is configured to be urged inwardly by a pressing force that can be applied by an inner surface of the bore 133 when the outer body 130 is slid over the second inner body 156. The inner surface of the bore 133 includes an inward projection 139 that is configured to depress and move past the latching portion 173 when the outer body 130 is slid over the second inner body 156 toward the end surface 180. After the projection 139 passes the latching portion 173, the bias of the latching portion 173 moves the latching portion 173 outward against the bore 133 such that the projection 139 prevents the second inner body 156 from sliding out of the front end of the connector.

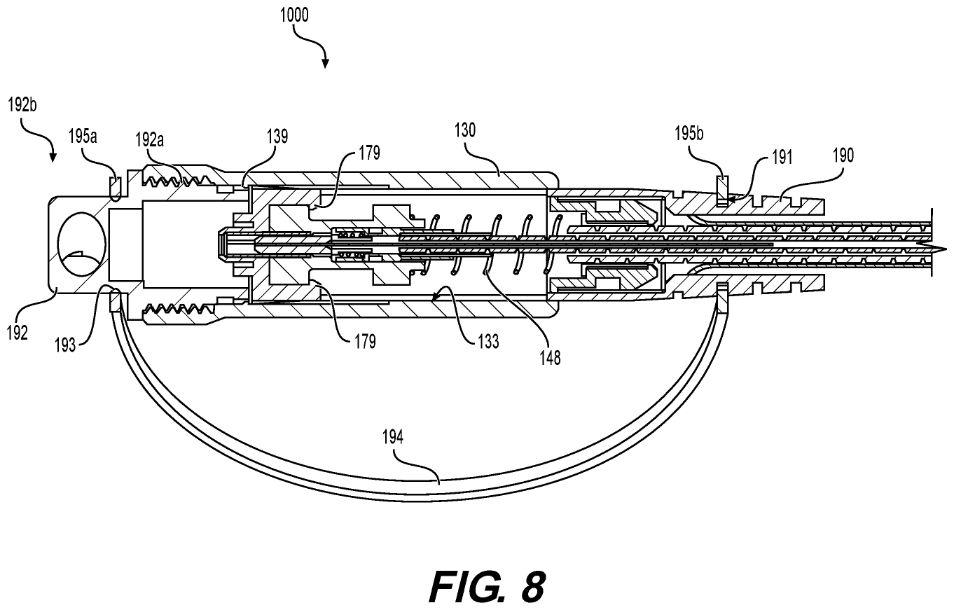

A pair of fingers 178 extend in the axial direction from the third and fourth outer surfaces 176c, 176d of the wall portion 176 toward the first end inner body 152. Radially outer surfaces 178a of the fingers 178 are curved to match the curvature of the notches 177, and radially inner surfaces 178b of the fingers 178 are substantially planar. The fingers 178 are configured to be received by the notches 165 of the second end portion 162 of the first inner body 152. Each of the fingers 178 includes a lip portion 179 that extends radially inward at a free end 178a of the finger 178. The lip portion 179 extends radially inward by a distance that permits the lip portion 179 to overlap the second surface 163b of the second end portion 162 of the first inner body 152, as best shown in FIG. 8. The fingers 178 are radially flexible such that the fingers 178 can be urged radially outward when the fingers 178 are slid over the notches 165 and return toward their rest configuration when the lip portions 179 overlap the second surface 163b. When the lip portions 179 overlap the second surface 163b, the first inner body 152 is axially fixed relative to the second inner body 156.

The wall portion 176 of the second inner body 156 includes an end surface 180 facing in a direction away from the first inner body 152, a cylindrical projection 182 extending from the end surface 180 in the axial direction, and a square keyway 184 surrounding the cylindrical projection 182 and extending from the end surface 180 in the axial direction. The cylindrical projection 182 includes an opening 183 sized to receive the split sleeve 154 in a compressed configuration such that the split sleeve 154 is biased radially outward against the wall of the opening 183 to maintain a coupled relationship with the second inner body 156. As best shown in FIG. 5, a free end 185 of the cylindrical projection 182 includes a lip portion 182a that extends radially inward and is sized and configured to prevent the split sleeve 154 from sliding out of the free end 185 of the cylindrical projection 182.

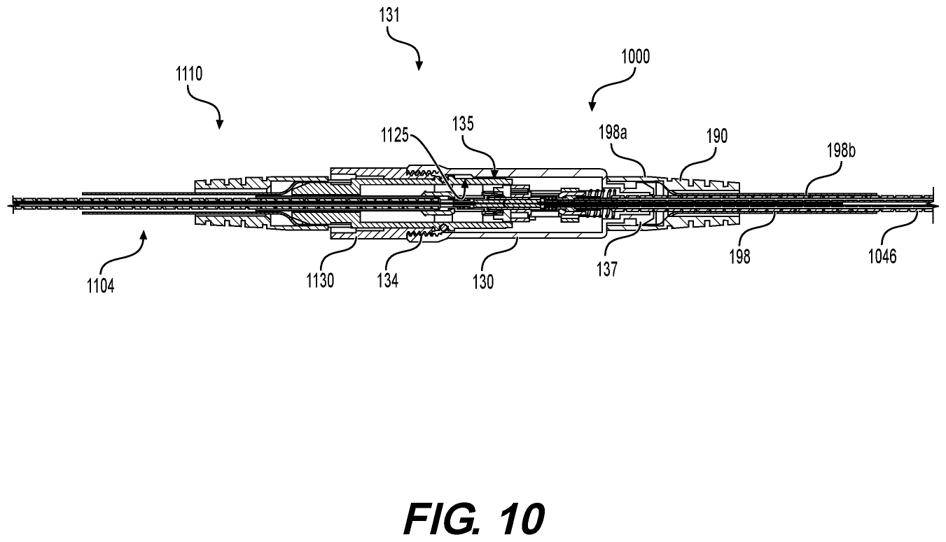

Referring to FIGS. 5, 6, 8, 10, and 11, the outer body 130 includes a first end 131, an opposite second end 132, and a bore 133 extending from the first end 131 to the second end 132. The first end 131 includes an internal threaded portion 134 and a keyed portion 135 spaced from the threaded portion 134 in the axial direction toward the second end 132. The bore 133 is sized to receive a hardened fiber optic connector 1110, for example, an OptiTap® connector. For example, the bore 133 is substantially cylindrical, but includes a flattened region 135a at the keyed portion 135 configured to receive a complementary shaped keyed portion 1112 of the hardened fiber optic connector 1110 to ensure proper alignment of the hardened fiber optic connector 1110 relative to the hardened fiber optic adapter 110. The square keyway 184 also ensures proper alignment of the hardened fiber optic connector 1110 relative to the hardened fiber optic adapter 110 such that a ferrule 1114 of the hardened fiber optic connector 1110 is received in the split sleeve 154 at the second inner body 156 and aligned with the ferrule 123 of the fiber connector 122.

The second end 132 of the outer body 130 includes a radially extending wall 136 and an external barbed portion 137 extending from the wall 136 in the axial direction away from the first end 131. The barbed portion 137 has an outer diameter than is less than an outer diameter of a remainder of the outer body 130. The barbed portion 137 is sized to receive a first end 198a of the heat shrink 198 and a first end 190a of the boot 190 thereon. The barbed portion 137 includes a stepped inner wall 138 that defines a surface 138a that faces in the axial direction toward the first end 131 and against which a head end portion 146a of the crimp 146 may be engaged. A free end of the barbed portion 137 includes a lip portion 137a that extends radially inward.

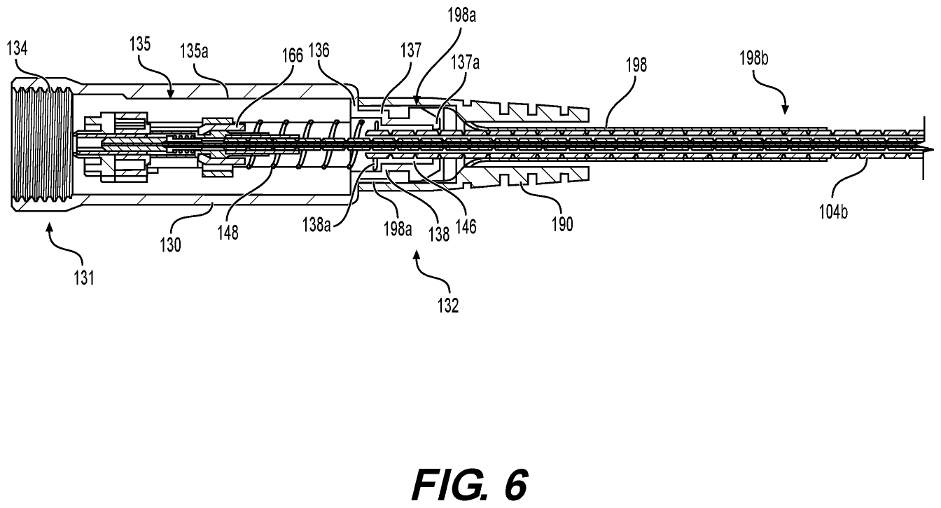

Referring again to FIG. 6, an adapter assembly 1000, for example, a hardened fiber optic adapter assembly, is illustrated. The adapter assembly 1000 includes the hardened fiber optic adapter 110 coupled with the output fiber optic cable 104. To assemble the adapter assembly 1000, the boot 190, the heat shrink 198, the outer body 130, and the crimp 146 are slid over the fiber connector 122 and the protection tube 104b in that order.

The adapter subassembly 150 is assembled by inserting the split sleeve 154 into the first inner body 152 and into the second inner body 156 from the direction of the first inner body 152. The first and second inner bodies 152, 156 are coupled to one another by aligning the fingers 178 of the second inner body 156 with the notches 165 of the first inner body 152 and sliding the fingers 178 over the notches 165 until the lip portions 179 of the fingers 178 overlap the second surface 163b of the first inner body 152. The adapter subassembly 150 can be assembled before or after the aforementioned elements are slid over the fiber connector 122 and the protection tube 104b, as described above.

The crimp 146 is crimped onto an end portion of the protection tube 104b, and a second end 148b of the spring 148 is slid over the fiber connector 122, an exposed portion of the fiber cable 104a, and an end portion of the protection tube 104b to the head end portion 146a of the crimp 146. The adapter subassembly 150 is then slid over the fiber connector 122 until the lip portions 172 of the fingers 170 are received in the neck portion 125 of the ferrule holder 124 and with the ferrule 123 received in the split sleeve 154 and the first end 148a of the spring 148 disposed on the circular end wall 166 of the first end portion 160. The spring 148 is configured to urge the adapter subassembly 150 in the axial direction toward the first end 131 of the outer body 130.

The outer body 130 is then slid over the protection tube 104b in a direction toward the fiber connector 122 until the radial lip portion 137a of the barbed portion 137 engages a second end 146b of the crimp 146. The first end portion 198a of the heat shrink 198 is slid over the barbed portion 137 of the outer body 130, a second end portion 198b of the heat shrink 198 remains over a portion of the protection tube 104b, and the heat shrink 198 is then heat shrunk onto the barbed portion 137 and the protection tube 104b. The boot 190 is then slid over the heat shrink 198 and onto the barbed portion 137 of the outer body 130. The boot 190 may be a flexible member that allows an interface between adapter 110 and the optical fiber cable 140 to bend and rotate. For example, the boot 190 may be formed from a flexible material such as KRAYTON®.

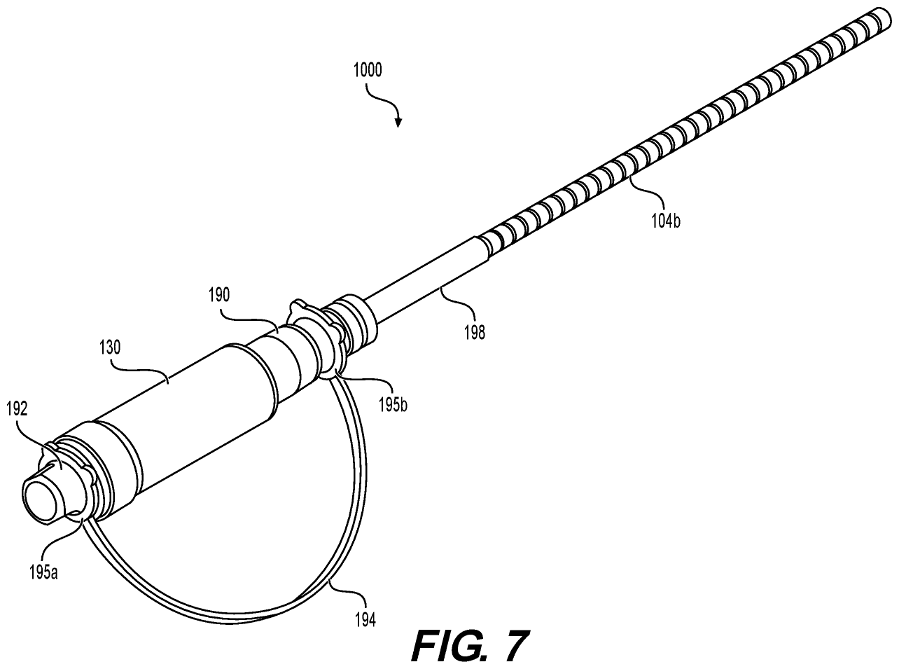

FIGS. 7 and 8 illustrate the adapter assembly 1000 with the dust cap 192 coupled with the first end 131 of the outer body 130. The dust cap 192 includes an externally threaded first end 192a that is configured to be threadedly coupled with the internal threaded portion 134 of the first end 131 of the outer body 130. A second end 192b of the dust cap 192 includes a groove 193 configured to receive a first ring 195a of the tether 194 to couple the tether 194 to the dust cap 192. The tether 194 includes a second ring 195b configured to be received in a groove 191 in the outer surface of the boot 190 to couple the tether 194 to the boot 190, thereby coupling the dust cap 192 to the boot 190.

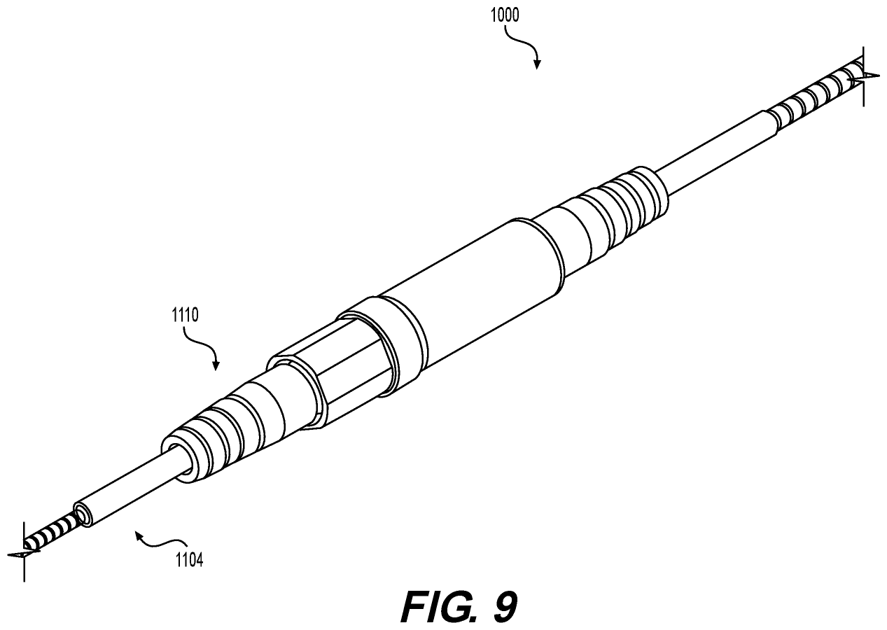

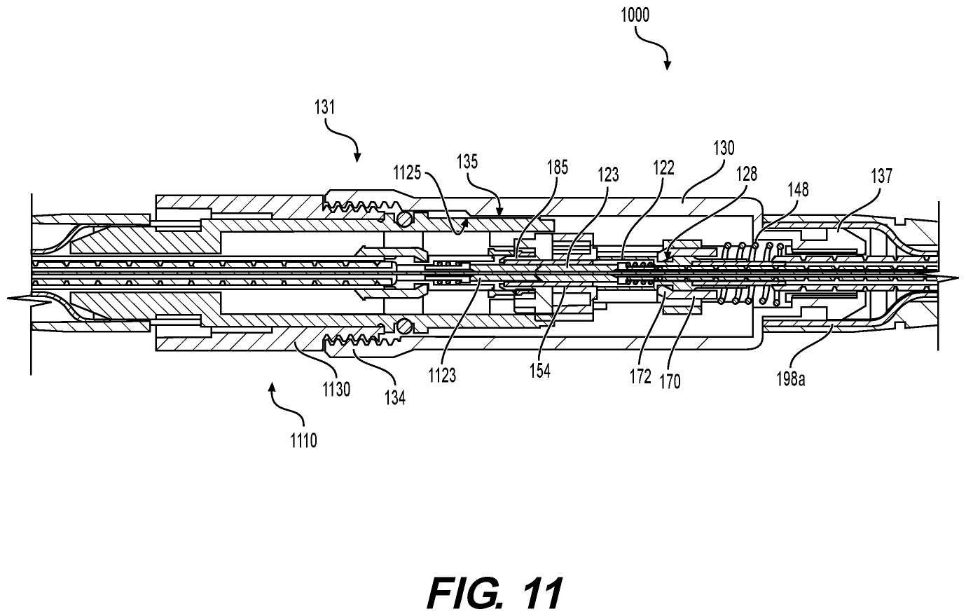

FIGS. 9-11 illustrate the adapter assembly 1000 coupled with a hardened fiber optic connector 1110 that terminates a drop fiber cable 1104. As best shown in FIG. 11, a ferrule 1123 of the hardened fiber optic connector 1110 is received in the split sleeve 154 via the cylindrical portion 182, and a keyed portion 1112 of the hardened fiber optic connector 1110 is received in the keyed portion 135 of the outer body 130. The hardened fiber optic connector 1110 includes a threaded coupler 1130 configured to be threadedly coupled with the internal threaded portion 134 of the first end 131 of the outer body 130.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A hardened fiber optic adapter that is configured to couple a hardened fiber optic connector with a fiber cable lead of a drop terminal, comprising:
a body portion having a first end portion configured to receive a hardened fiber optic connector and a second end portion opposite to the first end portion;
a flexible fiber cable lead portion including an optical fiber cable and a protection tube portion configured to surround at least a portion of the optical fiber cable;
an adapter subassembly portion configured to be coupled with a preterminated end of the optical fiber cable at a first end portion of the flexible fiber cable lead;
a crimp member configured to couple the protection tube portion of the flexible fiber cable lead portion with the body portion at the second end portion of the body portion;
a biasing member configured to urge the adapter subassembly portion in axial direction toward the first end portion of the body portion;
wherein the first end portion of the body portion is configured to include an internal threaded portion that is configured to be threadedly coupled with an external threaded portion of a hardened fiber optic connector;
wherein the adapter subassembly portion includes a first inner body portion and a second inner body portion that are configured to be fixedly coupled together and to receive a split sleeve configured to extend through coaxial openings in the first inner body portion and the second inner body portion;
wherein the first inner body portion is configured to be coupled with a ferrule holder portion of the preterminated end of the optical fiber cable to axially fix the ferrule holder portion with the first inner body portion;
wherein the adapter subassembly portion is configured to provide an interface that is configured to mechanically and optically couple the preterminated end of the optical fiber cable with a hardened fiber optic connector that is threadedly coupled with the internal threaded portion at the first end portion of the body portion;
wherein the split sleeve is configured to receive and align a ferrule of the preterminated end of the optical fiber cable with a ferrule of a hardened fiber optic connector that is threadedly coupled with the internal threaded portion at the first end portion of the body portion;
wherein the body portion includes a keyed receptable portion that is configured to receive a keyed plug portion of a hardened fiber optic connector so as to provide a first predetermined connection orientation so as to allow the hardened fiber optic connector to be connected with the body portion at the predetermined connection orientation; and
wherein a second end portion of the flexible fiber cable lead portion is configured to be coupled with a drop terminal such that the adapter is permitted to be moved relative to the drop terminal to a second predetermined connection orientation that is configured to allow the adapter to be connected to a hardened fiber optic connector.

2. The adapter of claim 1, further comprising a heat shrink that is configured to be applied to an outside of the flexible fiber cable lead portion and the second end portion of the body portion to provide a weathertight seal at the connection there between.

3. The adapter of claim 1, wherein the biasing member comprises a spring.

4. The adapter of claim 1, wherein the optical fiber cable comprises a cable having annular grooves spaced apart from one another along a length of the cable.

5. The adapter of claim 1, wherein the protection tube portion comprises a duct having annular grooves spaced apart from one another along a length of the duct.

6. A hardened fiber optic adapter that is configured to couple a hardened fiber optic connector with a fiber cable lead of a drop terminal, comprising:
a body portion having a first end portion that is configured to receive a hardened fiber optic connector and a second end portion opposite to the first end portion;
a flexible fiber cable lead portion that includes an optical fiber cable and a protection tube portion that is configured to surround at least a portion of the optical fiber cable;
an adapter subassembly portion configured to be coupled with a preterminated end of the optical fiber cable at a first end portion of the flexible fiber cable lead;
wherein the adapter subassembly portion is configured to be coupled with a ferrule holder portion of the preterminated end of the optical fiber cable to axially engage the ferrule holder portion with the adapter subassembly portion;
wherein the adapter subassembly portion is configured to provide an interface that is configured to mechanically and optically couple the preterminated end of the optical fiber cable with a hardened fiber optic connector that is coupled with the first end portion of the body portion; and
wherein a second end portion of the flexible fiber cable lead portion is configured to be coupled with a drop terminal such that the adapter is permitted to be moved relative to the drop terminal to a predetermined connector orientation that is configured to allow the adapter to be connected to a hardened fiber optic connector.

7. The adapter of claim 6, further comprising a heat shrink that is configured to be applied to an outside of the flexible fiber cable lead portion and the second end portion of the body portion so as to provide a weathertight seal at a connection portion there between.

8. The adapter of claim 6, wherein the optical fiber cable comprises a cable having annular grooves spaced apart from one another along a length of the cable.

9. The adapter of claim 6, wherein the protection tube portion comprises a duct having annular grooves spaced apart from one another along a length of the duct.

10. The adapter of claim 6, further comprising a crimp member that is configured to couple the protection tube portion of the flexible fiber cable lead portion with the body portion at the second end portion of the body portion.

11. The adapter of claim 6, further comprising a biasing member that is configured to urge the adapter subassembly portion in axial direction toward the first end portion of the body portion.

12. The adapter of claim 11, wherein the biasing member comprises a spring.

13. The adapter of claim 6, wherein the first end portion of the body portion is configured to include an internal threaded portion that is configured to be threadedly coupled with an external threaded portion of a hardened fiber optic connector.

14. The adapter of claim 6, wherein the adapter subassembly includes a first inner body portion and a second inner body portion that are configured to be fixedly coupled together.

15. The adapter of claim 6, wherein the adapter subassembly is configured to receive a split sleeve that is configured to extend through an opening in the adapter subassembly, and wherein the split sleeve is configured to receive and align a ferrule of the preterminated end of the optical fiber cable with a ferrule of a hardened fiber optic connector that is coupled with the first end portion of the body portion.

16. The adapter of claim 6, wherein the predetermined connection orientation comprises a first predetermined connection orientation, and the body portion includes a keyed receptable portion that is configured to selectively receive a keyed plug portion of a hardened fiber optic connector so as to provide a second predetermined connection orientation that is configured to allow the hardened fiber optic connector to be connected to the body portion.

17. The adapter of claim 6, wherein the adapter subassembly portion is configured to be coupled with a ferrule holder portion of the preterminated end of the optical fiber cable to axially fix the ferrule holder portion with the adapter subassembly portion.

18. A hardened fiber optic adapter that is designed to couple a hardened fiber optic connector with a fiber cable lead of a drop terminal, comprising:
a body portion having a first end portion that is configured to receive a hardened fiber optic connector and a second end portion;
a flexible fiber cable lead portion including an optical fiber cable and a protection tube portion that is configured to surround at least a portion of the optical fiber cable;
an adapter subassembly portion configured to be coupled with a preterminated end of the optical fiber cable; and
wherein a second end portion of the flexible fiber cable lead portion is configured to be coupled with a drop terminal such that the adapter is permitted to be moved relative to the drop terminal to a predetermined connection orientation that is configured to allow the adapter to be connected to a hardened fiber optic connector.

19. The adapter of claim 18, further comprising a heat shrink that is configured to be applied to an outside of the flexible fiber cable lead portion and the second end portion of the body portion so to provide a weathertight seal at a connection portion there between.

20. The adapter of claim 18, wherein the optical fiber cable comprises a cable having annular grooves that are spaced apart from one another along a length of the cable.

21. The adapter of claim 18, wherein the protection tube portion comprises a duct having annular grooves that are spaced apart from one another along a length of the duct.

22. The adapter of claim 18, further comprising a crimp member that is configured to couple the protection tube portion of the flexible fiber cable lead portion with the body portion at the second end portion of the body portion.

23. The adapter of claim 18, further comprising a biasing member that is configured to urge the adapter subassembly portion in an axial direction toward the first end portion of the body portion.

24. The adapter of claim 23, wherein the biasing member comprises a spring.

25. The adapter of claim 18, wherein the first end portion of the body portion is configured to include an internal threaded portion that is configured to be threadedly coupled with an external threaded portion of a hardened fiber optic connector.

26. The adapter of claim 18, wherein the adapter subassembly includes a first inner body portion and a second inner body portion that are configured to be fixedly coupled together.

27. The adapter of claim 18, wherein the adapter subassembly is configured to receive a split sleeve that is configured to extend through an opening in the adapter subassembly, and wherein the split sleeve is configured to receive and align a ferrule of the preterminated end of the optical fiber cable with a ferrule of a hardened fiber optic connector that is coupled with the first end portion of the body portion.

28. The adapter of claim 18, wherein the predetermined connection orientation comprise a first predetermined connection orientation, and the body portion includes a keyed receptable portion that is configured to receive a keyed plug portion of a hardened fiber optic connector to provide a second predetermined connection orientation that is configured to allow the hardened fiber optic connector to be connected to the body portion.

29. The adapter of claim 18, wherein the adapter subassembly portion is configured to be coupled with a ferrule holder portion of the preterminated end of the optical fiber cable to axially fix the ferrule holder portion with the adapter subassembly portion.

30. The adapter of claim 18, wherein the adapter subassembly portion is configured to provide an interface that is configured to mechanically and optically couple the preterminated end of the optical fiber cable with a hardened fiber optic connector that is coupled with the first end portion of the body portion.

31. The adapter of claim 18, wherein the second end portion is opposite to the first end portion.

32. The adapter of claim 18, wherein the adapter subassembly portion is configured to be coupled with the preterminated end of the optical fiber cable at a first end portion of the flexible fiber cable lead.
